(19) United States
(12) Patent Application Publication
(10) Pub. No.: US 2012/0191765 A1
(43) Pub. Date: Jul. 26, 2012

(54) Information Processing Apparatus

(75) Inventors: Shinichi Tanaka, Kanagawa (JP); Shingo Kannari, Tokyo (JP); Kazuhiro Kanee, Chiba (JP); Akiyuki Hatakeyama, Tokyo (JP)

(73) Assignee: SONY COMPUTER ENTERTAINMENT INC., Tokyo (JP)

(21) Appl. No.: 13/349,165

(22) Filed: Jan. 12, 2012

(30) Foreign Application Priority Data
Jan. 25, 2011 (JP) 2011-013409

(51) Int. Cl. G06F 17/30

(52) U.S. Cl. 707/821; 707/E17.01

(57) ABSTRACT

A game recording medium records game files each containing at least a game program and configuration information with which to identify a data file usable by the game program. A recording medium records data files. An acquisition unit acquires the configuration information from the game recording medium, and a search unit searches the recording medium for the data file usable by the game program, based on the acquired configuration information. When a data file is detected, a copying unit copies the detected data file to the game recording medium.

### BACKGROUND OF THE INVENTION

1. Field of the Invention

The present invention relates to an information processing technique implemented by an information processing apparatus such as a game device.

2. Description of the Related Art

In the on-going practice, game software are distributed and sold in the form of an ROM medium such as an optical disk, magneto-optical disk, or Blu-ray disk. The game software recorded in a ROM medium cannot be rewritten, and so patches are applied when bugs, if any, in parts of the game software are to be fixed or the functions are to be altered. Reference (1) in the following Related Art List, for example, discloses a game device that performs game booting by loading into memory a boot file with newer version information after comparing the version information contained in a patch file against the version information recorded in a recording medium.

### RELATED ART LIST

(1) United States Patent Application Publication No. 2008/0141018 A1

With the development of the Internet, an environment has been created in which game files, including game programs, and patch files are distributed from servers to user terminals over the Internet. In such an environment, new game characters can be added to the original game when the user terminal downloads a data file containing the new characters not existing in the original game and so forth.

On the other hand, game software are distributed and sold in the form of recording medium to date. Since the game software are recorded in the ROM medium in the conventional practice, no additional data files can be written thereto. If, however, a writable storage area is provided in a recording medium where a game software is recorded, it is possible to write an additional data file containing new game characters and the like. Accordingly, all programs and data files necessary for the execution of a given game can be put into a single recording medium. Thus, the user can enjoy playing the game, in which the new characters appear, no matter to which game device the recording medium is mounted or inserted. The development of a system capable of efficiently writing a data file to a recording medium is therefore desired.

### SUMMARY OF THE INVENTION

A purpose of the present invention is therefore to provide a technology for effectively managing data of a recording medium.

In order to resolve the aforementioned problems, an information processing apparatus according to one embodiment of the present invention includes: a first recording medium configured to have recorded thereon an application file including an application program and configuration information with which to identify a data file usable by the application program; a second recording medium configured to have recorded thereon the data file; and a processor configured to have a function of copying the data file. The processor includes: an acquisition unit configured to acquire the configuration information from the first recording medium; a search unit configured to search the second recording medium for the data file usable by the application program, based on the configuration information acquired by the acquisition unit; and a copying unit configured to copy to the first recording medium the data file when the data file is detected by the search unit.

Optional combinations of the aforementioned constituting elements, and implementations of the invention in the form of methods, apparatuses, systems, recording medium, computer programs, and so forth may also be practiced as additional modes of the present invention.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 shows an information processing system according to an exemplary embodiment of the present invention;

FIG. 2 shows an example of the appearance of an information processing apparatus according to an exemplary embodiment of the present invention;

FIG. 3 shows functional blocks of an information processing apparatus;

FIG. 4A shows a basic directory structure of additional data files;

FIG. 4B shows a specific directory structure of an additional data file;

FIG. 5A shows a basic directory structure of a game file; FIG. 5B shows a specific directory structure of a game file;

FIG. 6 shows contents of a configuration file;

FIG. 7 shows functional blocks for executing a copying processing in an information processing apparatus; and

FIG. 8 shows a directory structure of an additional data file of copied “ABC TENNIS 1”.

### DETAILED DESCRIPTION OF THE INVENTION

The invention will now be described by reference to the preferred embodiments. This does not intend to limit the scope of the present invention, but to exemplify the invention.

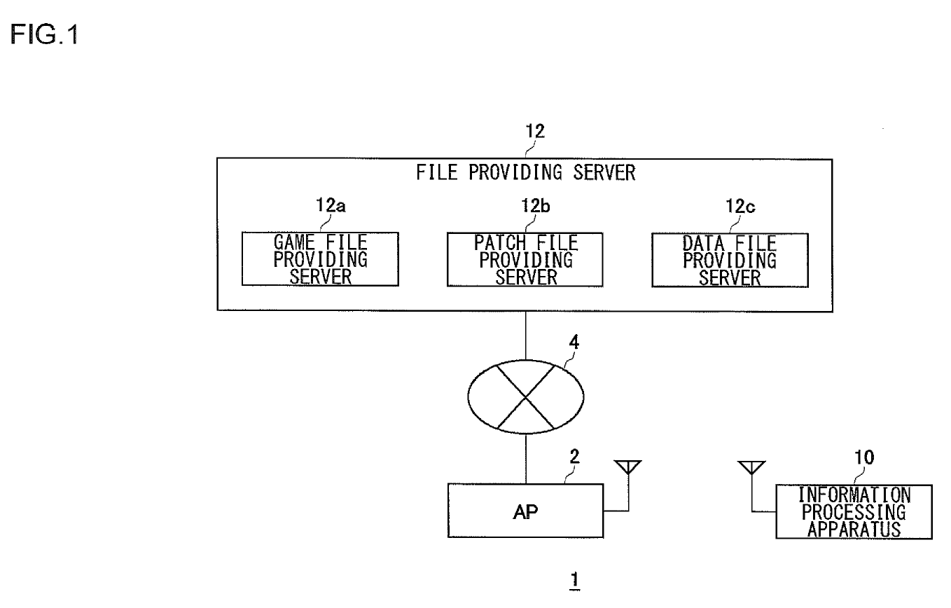

FIG. 1 shows an information processing system 1 according to an exemplary embodiment of the present invention. The information processing system 1 includes an information processing apparatus 10, which is a user terminal, and a file providing server 12. The file providing server 12 includes a game file providing server 12a, which provides game files including game programs, a patch file providing server 12b, which provides patch files to be applied to the games, and a data file providing server 12c, which provides data files to be used in the games.

The information processing apparatus 10, the game file providing server 12a, the patch file providing server 12b, and the data file providing server 12c are connected in a manner that permits communication via a network 4 such as the Internet or wired LAN. The information processing apparatus 10, which is equipped with a wireless communication function, downloads a desired file from the file providing server 12 by connecting to the network 4 via an access point (hereinafter referred to as “AP”) 2. The AP 2 functions as a relay unit that connects the information processing apparatus 10 to another access point by wireless LAN (Local Area Network) or connects the information processing apparatus 10 to the network 4. Thus the information processing apparatus 10 may have a communication function by wireless LAN, but the information processing apparatus 10 may also download files from the file providing server 12 by connecting to a mobile telephone network using a mobile telephone communication scheme such as the third-generation mobile communication system.

The game file providing server 12a, the patch file providing server 12b, and the data file providing server 12c may be constituted by a single server, but may also be constituted by a plurality of servers. Also, two or more combinations of the game file providing server 12a, the patch file providing server 12b, and the data file providing server 12c may be constituted by a single server.

The game file providing server 12a provides game files. A game file includes a boot file, a group of files for executing a game such as a game program, and a group of files to be used by the system software of the information processing apparatus 10. The game program is a program necessary for the execution of a game, and the game progresses as the game program is run. The boot file is a program for starting the game program, and the game program is called out and executed as the boot file is executed. The group of files to be used by the system software includes, for instance, game icon image data to be displayed on a menu image of the information processing apparatus 10.

The patch file providing server 12b provides a patch file to be applied to a game. The patch file includes a game program with the bugs fixed, a data file for changing game functions, and the like. The patch file has the same file composition as that of the game file and includes contents to be replaced with contents included in the game file. As used herein, the term “contents” or “content” refers collectively to programs, data files, and the like contained in the game file or the patch file.

The data file providing server 12c provides data files constituting new characters or game scenes that are to be added to the execution of an original game. The data files held by the data file providing server 12c are used in an additional manner along the progress of the original game and therefore these data files will be referred to as “additional data file” or “additional data files” hereinafter.

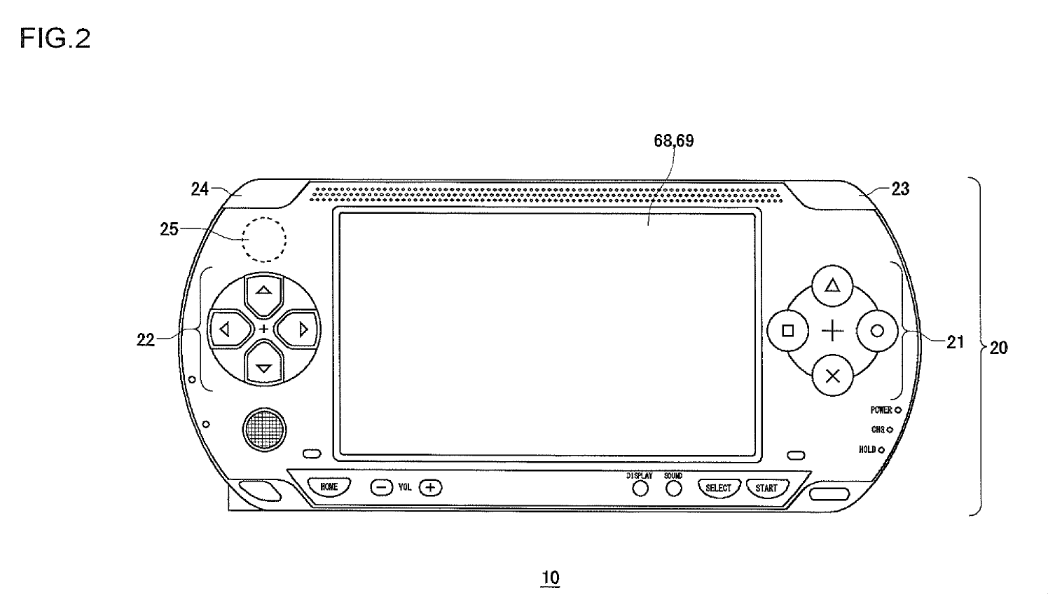

FIG. 2 shows an example of the appearance of an information processing apparatus 10 according to an exemplary embodiment of the present invention. The information processing apparatus 10 shown in FIG. 2 is a mobile terminal equipped with a wireless communication function. Also, it should be appreciated that the information processing apparatus 10 may be connected to the network 4 via cable and it may be a stationary terminal, instead of a mobile terminal.

As shown in FIG. 2, input devices 20, such as instruction input buttons 21, direction keys 22, an R button 23, and an L button 24, and a display device 68 are provided on the front side of the information processing apparatus 10, which is the side thereof facing the user who holds and operates it. The display device 68 is provided with a touch panel 69 that detects contact by a finger of the user or a stylus pen or the like. Provided inside the information processing apparatus 10 is a motion sensor 25 capable of detecting the inclination of the information processing apparatus 10. It should be noted also that the information processing apparatus 10 may be provided with a back touch panel on the back side thereof.

Provided in a lateral side of the information processing apparatus 10 is a receiving section, such as a slot (not shown), for receiving a recording medium like a memory card. Also provided in a lateral side of the information processing apparatus 10 is a receiving section, such as a slot (not shown), for receiving a recording medium which has a game file recorded thereon.

The user, while holding the information processing apparatus 10 with both hands, can operate the instruction input buttons 21 with the thumb of the right hand, the direction keys 22 with the thumb of the left hand, the R button 23 with the index finger or the middle finger of the right hand, and the L button 24 with the index finger or the middle finger of the left hand, for instance. Also, when operating the touch panel 69, the user may hold the information processing apparatus 10 with both hands and operate the touch panel 69 with the thumbs of both hands, or may hold the information processing apparatus 10 with the left hand and operate the touch panel 69 with the right hand, the direction keys 22 with the thumb of the left hand, and the L button 24 with the index finger or the middle finger of the left hand.

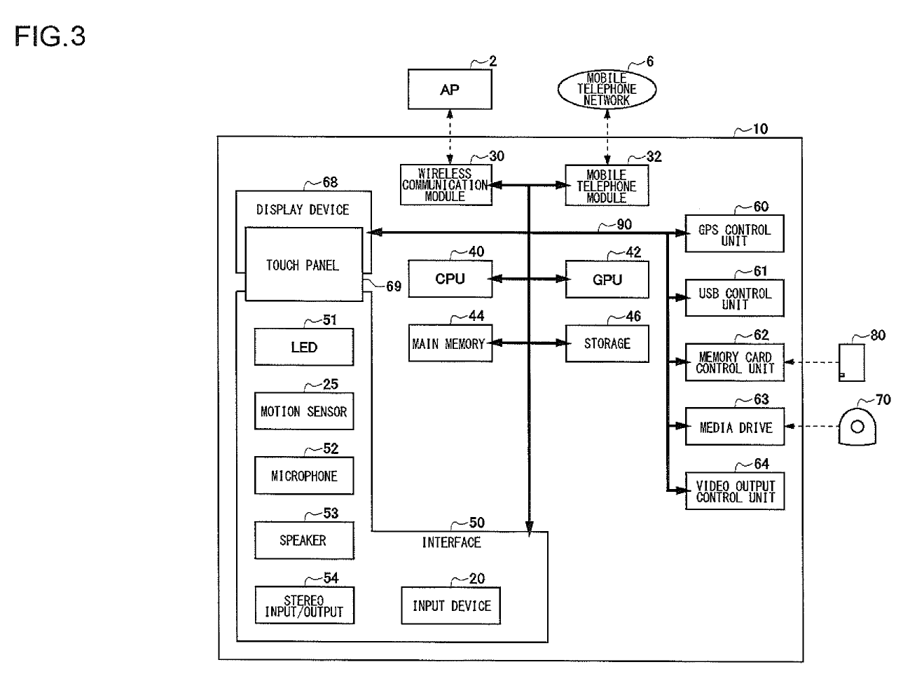

FIG. 3 shows functional blocks of the information processing apparatus 10. The display device 68 display images generated by the respective functions of the information processing apparatus 10. The display device 68 may be a liquid crystal display device or an organic EL display device. The touch panel 69 is so provided as to be superimposed on the display device 68, and detects the touch or contact of a user's finger, pen or the like. The touch panel may implement any of a resistive overlay method, a surface electrostatic capacitive method, a projected electrostatic capacitive method, and the like. In the information processing apparatus 10, the display is comprised of the display device 68 and the touch panel 69.

A wireless communication module 30 is constituted by a wireless LAN module compliant with a communication standard such as IEEE 802.11b/g, and connects to the network 4 via the AP 2. The wireless communication module 30 may communicate directly with the other information processing apparatus 10 in ad-hoc mode. A mobile telephone module 32 is compatible with a third digital mobile telephone scheme compliant with the international mobile telecommunication 2000 (IMT-2000) standard prescribed by the International Telecommunication Union (ITU), and the mobile telephone module 32 connects to a mobile telephone network 6. A subscriber identity module (SIM) card, in which a unique ID number to identify a telephone number of a mobile telephone has been recorded, is inserted to the mobile telephone module 32.

In an interface 50, an LED (light emitting diode) 51 blinks while the wireless communication module 30, the mobile telephone module 32, and the like transmit and receive data. A motion sensor 25 detects the movement of the information processing apparatus 10. A microphone 52 inputs sound surrounding the information processing apparatus 10. A speaker 53 outputs audio generated by the respective functions of the information processing apparatus 10. A stereo input/output terminal 54 receives the input of stereo audio from an external microphone, and outputs the stereo audio to an external headphone or the like. An input device 20 includes the aforementioned operation keys and the like and receives the input of a user's operation.

A CPU (central processing unit) 40 executes programs and the like loaded in main memory 44. A GPU (graphics processing unit) 42 performs computations necessary for the image processing. The main memory 44 is comprised of RAM (random access memory) and the like, and stores programs, data, and so forth that run and operate in the information processing apparatus 10. A storage 46 is comprised of NAND-type flash memory and the like, and stores programs, data, and so forth. The storage 46 is used as a built-in type auxiliary storage for a recording medium 80 (described later).

A GPS (global positioning system) control unit 60 receives signals from GPS satellites and computes the present position. A USB (universal serial bus) control unit 61 controls communications between peripheral devices connected via USBs. A video output control unit 64 outputs video signals to an external display device, based on a standard such as HDMI (high definition multimedia interface). A memory card control unit 62 controls read and write of data between the recording medium 80 such as flash memories and the like loaded in the receiving section (not shown). As the removable recording medium 80 is loaded (inserted) into the receiving section, the recording medium 80 is used as an external auxiliary storage. A media drive 63 is a receiving section in which a game recording medium 70 that has recorded game files is loaded, and the media drive 63 controls read and write of data between the game recording medium 70. The above-described respective functional blocks are connected with each other by a bus 90.

The game recording medium 70 is a cartridge-type recording medium where game files are recorded in a read-only area, and the game recording medium 70 are sold and distributed through game shops or virtual game shops on the Internet. The user, who has purchased a game recording medium 70, can enjoy playing the game by loading the game recording medium in the media drive 63.

A writable storage area is provided and reserved in the game recording medium 70, and a file, such as a patch file, and/or an additional data file necessary for the game can be written to the writable storage area. Thus, the game recording medium 70 is comprised of the writable/readable area and the read-only area where the game files are recorded.

Note that the information processing apparatus 10 according to the present exemplary embodiment can download the game file from the game file providing server 12a and install the downloaded game file into the recording medium 80. Thus, the information processing apparatus 10 has a function of executing game files recorded in the game recording medium 70 or those installed into the recording medium 80.

A description is now given of the technical background and the summary of exemplary embodiments. There are so-called “serial” games in the games and, in particular, some of popular games among them are released every few years with a new version. In such serial games, many of games are provided with a function with which a data file of older game can be carried on into a new game so as to give a motive to buy a new game.

Suppose, for example, that in the past the user played a game called “ABC TENNIS 1” by installing a game file of “ABC TENNIS 1” into the recording medium 80. Here, “1” included in the title of the game “ABC TENNIS 1” means the version 1 in the “ABC TENNIS” serial. The user downloads an additional data file from the data file providing server 12c and adds new characters and the like so as to play the game “ABC TENNIS 1”.

Under such circumstances, the user purchases a game recording medium 70 of “ABC TENNIS 2”. “2” included in the title of the game “ABC TENNIS 2” means the version 2 in the “ABC TENNIS” serial. In the version information, the larger the number the newer the version is. Thus, the game file of “ABC TENNIS 2” with a newer version than the version of “ABC TENNIS 1” is recorded in the game recording medium 70. In “ABC TENNIS 2”, the setting is implemented such the additional data file of “ABC TENNIS 1” is usable in the “ABC TENNIS 2”.

After the user loads the game recording medium 70 in the media drive 63, the system software of the information processing apparatus 10 searches the recording medium 80 for the presence of any data file that can be used by “ABC TENNIS 2” prior to the start of “ABC TENNIS 2”. Since, in this case, there exists an additional data file for “ABC TENNIS 1” in the recording medium 80, the system software copies the additional data file of “ABC TENNIS 1” to a writable area of the game recording medium 70. Thereby, the additional data file, which can be used for the execution of the game “ABC TENNIS 2”, can be included a single game recording medium 70. Thus, even when the game recording medium 70 is loaded in another information processing apparatus, the user can still use the additional data file of “ABC TENNIS 1”.

When the information processing apparatus 10 downloads a patch file and an additional data file of “ABC TENNIS 2” from the file providing server 12, these files are all recorded in the game recording medium 70. As a result, the program file and data file required for the execution of the game “ABC TENNIS 2” can all be included in the single game recording medium 70.

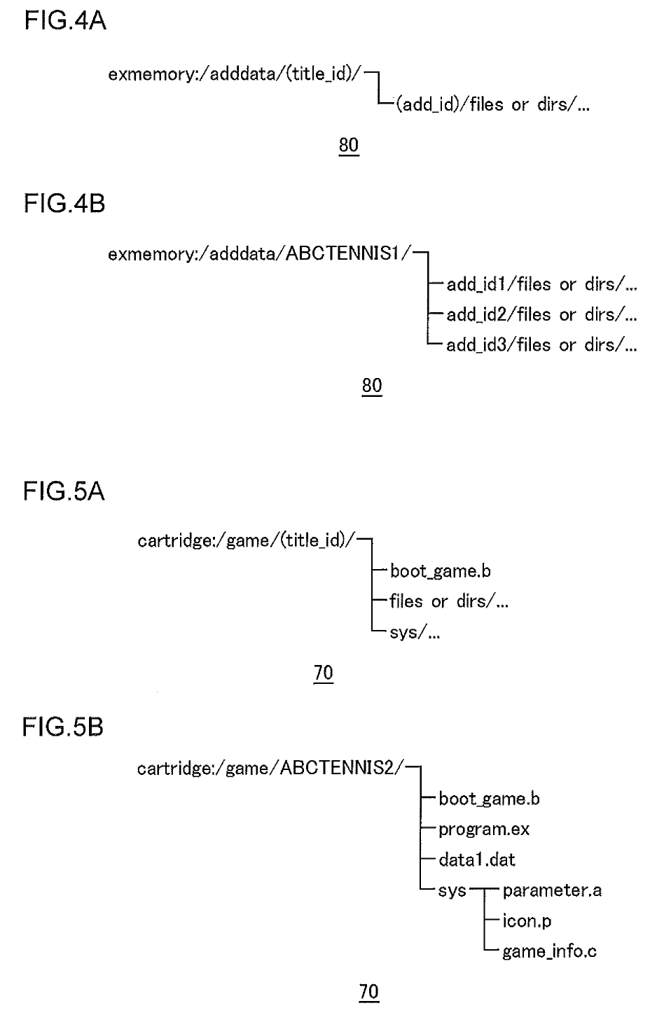

FIG. 4A shows a basic directory structure of an additional data file. Here “exmemory:” specifies the recording medium 80, and the directory structure shown in FIG. 4A indicates the storage locations within the recording medium 80. The additional data files are stored in the “adddata” directory. All of the additional data files have each a title ID to identify a game and its additional data ID for identification, and each additional data file in the “adddata” directory is stored in a subdirectory identified by the title ID (title_id) and the additional data ID (add_id). It is to be noted that the “title_id” constituting a subdirectory may be a title ID itself or a code generated from the title ID. For convenience of explanation, a description is hereinbelow given in such a manner that the title ID is replaced by the game title but the title ID may actually be a product number expressed by a binary code. “files or dirs”, which represents files or directories collectively, shows the state in which files constituting additional data are stored.

FIG. 4B shows a directory structure of additional data files for “ABC TENNIS 1”. The identification information concerning the game title “ABC TENNIS 1” is set in “(title_id)” but, as described above, the game title is stated for convenience, instead. In this example, three additional data files where add_id1, add_id2, and add_id3 are used as the additional data IDs are recorded in the recording medium 80, and these data files are stored in the directories identified by the their respective additional data IDs.

FIG. 5A shows a basic directory structure of game files. Here “cartridge:” specifies the game recording medium 70, and the directory structure shown in FIG. 5A indicates the storage locations within the game recording medium 70. The game files are stored in a “game” directory. The storage area identified by the “game” directory in the game recording medium 70 is a read-only and there no alteration, addition, deletion and the like of data are allowed.

The game files have each a title ID for unique identification, and each game file in the “game” directory is stored in a subdirectory identified by the title ID (title_id). It is to be noted that the “title_id” constituting a subdirectory may be a title ID itself or a code generated from the title ID.

“boot_game.b” represents a boot file which the system software initially starts upon receipt of a boot instruction from the user. “files or dirs”, which represents files or directories collectively, shows the state in which a group of files constituting a game is stored. “sys” stores a group of files used by the system software. This group of files includes a configuration file defining a title ID, an icon image file to be displayed on the menu screen by the system software, and the like.

FIG. 5B shows a directory structure of a game file of “ABC TENNIS 2”. The identification information concerning the game title “ABC TENNIS 2” is set in “(title_id)” but, as described above, the game title is stated for convenience, instead. “boot_game.b” is the boot file of the game, “program.ex” is the program file of the game, and “data1.dat” is the data file of the game, respectively.

“parameter.a” in a “sys” directory is the configuration file of the game used by the system software. “icon0.p” in the “sys” directory is icon image data displayed on the menu image. “game_info.c” in the “sys” directory is information data displayed on the menu image.

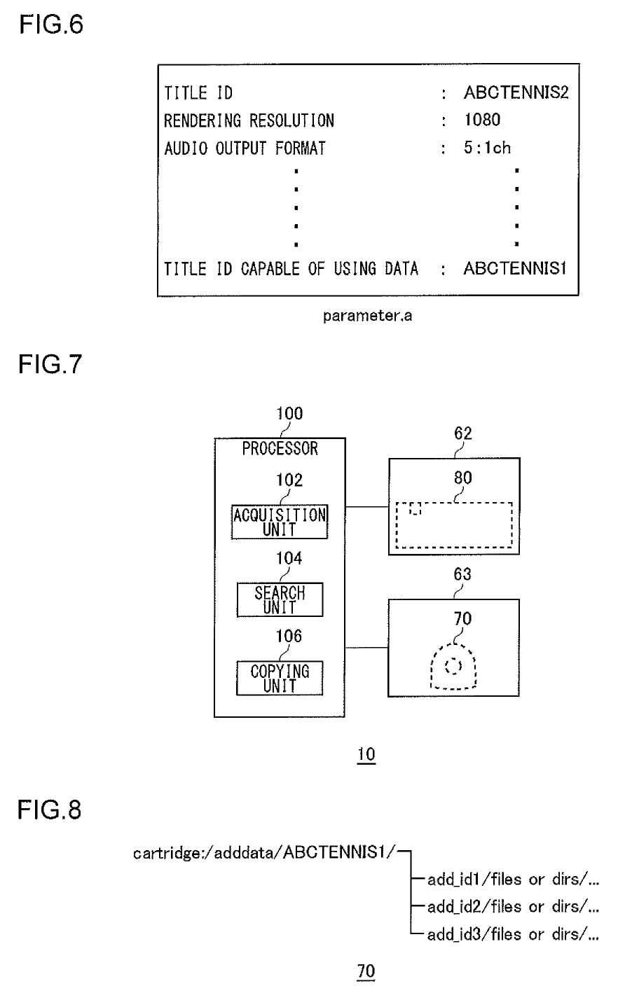

FIG. 6 shows contents of the configuration file. The configuration file (parameter.a) may be a file in XML format. The configuration file includes configuration information which are a title ID, rendering resolution, audio output format, and a title ID capable of using data. In the example of FIG. 6, the title ID is set to “ABC TENNIS 2”, the rendering resolution is set to “1920×1080”, and the audio output format is set to “5.1 ch”.

In the present exemplary embodiment, the “title ID capable of using data” is the configuration information used to identify data files usable by the game program, that is, the information concerning the title ID of a game for which the additional data files can be used. In the so-called serial games, there are cases where newer-version games are so designed and structured as to be capable of using the data files of older-version games. In the present exemplary embodiment, “ABC TENNIS 2” is so designed and structured that the additional data file of “ABC TENNIS 1” can be used for “ABC TENNIS 2”. Thus, the “title ID capable of using data” is set to “ABC TENNIS 1”. The “title ID capable of using data” will be hereinafter referred to as “usable ID”.

FIG. 7 shows functional blocks for executing a copying processing in an information processing apparatus 10. The main memory 44, the GPU 42 and the like are omitted in FIG. 7. The information processing apparatus 10 includes a processor 100, a game recording medium 70, and a recording medium 80. Here, the game recording medium 70 constitutes a first recording medium configured to have recorded thereon game files including at least game programs and configuration information with which to identify data files usable by the game programs. Also, the recording medium 80 constitutes a second recording medium configured to have recorded thereon the additional data files. The processor 100, which has a function of copying the data files, includes an acquisition unit 102, a search unit 104, and a copying unit 106.

Those components of the processor 100 are realized, in terms of hardware components, by the CPU 40, the main memory 44 and the like, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

The copying function performed by the processor 100 is implemented by the system software of the information processing apparatus 10. The system software, upon detecting the loading of the game recording medium 70 in the media drive 63, automatically runs the copying function by the processor 100. It should be noted that this copying function may be implemented by the system software itself or also by the utility software.

The acquisition unit 102 references files included in the sys directory (see FIG. 5B) from the game files recorded in the game recording medium 70, and acquires the configuration file (parameter.a). The configuration file includes the configuration information (usable ID) used to identify the data file usable by the game program of “ABC TENNIS 1” recorded in the game recording medium 70.

The search unit 104 searches the recording medium 80 (see FIG. 4B) for the additional data file usable by the game program, based on the usable ID. In the exemplary embodiment, the usable ID is the title ID of a game (“ABC TENNIS 1”) that differs from “ABC TENNIS 2”, and the additional data file is stored in a directory, identified by the usable ID, of the recording medium 80. Thus, the search unit 104 can detect the data file usable by the game program of “ABC TENNIS 2” by finding the directory, identified by the usable ID, of the recording medium 80.

As the search unit 104 detects the additional data file of “ABC TENNIS 1”, the copying unit 106 copies the detected additional data file to the writable area of the game recording medium 70.

FIG. 8 shows a directory structure of the additional data file of “ABC TENNIS 1” copied by the search unit 104. The copying unit 106 directly copies the additional data file to the game recording medium 70 without modifying the directory structure of the additional data file in the recording medium 80. In this manner, after the game recording medium 70 is loaded in the receiving section of the media drive 63, the processor 100 automatically performs the copying function, which enables the recording of the additional data file of “ABC TENNIS 1” into the game recording medium 70 prior to the start of the game.

The present invention has been described based upon illustrative exemplary embodiments. The above-described exemplary embodiments are intended to be illustrative only and it will be obvious to those skilled in the art that various modifications to the combination of constituting elements and processes could be developed and that such modifications are also within the scope of the present invention. In the exemplary embodiments, games are cited and implemented as an example of applications but applications other than games may be implemented instead.

The copying function of the processor 100 is started whenever the game recording medium 70 is inserted into the receiving section of the media drive 63. Thus, when the additional data file detected by the search unit 104 has already been recorded in the game recording medium 70, the structure is such that the copying unit 106 does not copy the additional data file in the game recording medium 70. For example, a write processing may be controlled as follows. That is, the copying unit 106 acquires the additional data file from the game recording medium 70, compares the acquired data file with the information on the additional data file detected by the search unit 104, and the same additional data, if any, is not copied.

In the exemplary embodiments, a description has been given of the case where an additional data file is to be copied, but a save data file may also be included.

In the exemplary embodiments, a description has been given of the example where the ID of the title of a game that differs from the game recorded in the game recording medium 70 is included in the configuration file as the usable ID. However, the usable ID may further include additional data IDs. For example, “ABC TENNIS 2” may be set such that additional data files identified by the additional data IDs of add_id1 add_id2 are usable but an additional data file identified by the additional data ID of add_id3 is not usable. Also, the search unit 104 may search for usable additional data files, based on the usable IDs containing the additional data IDs.

Also, the same title IDs as the title IDs of games recorded in the game recording medium 70 may be included in the configuration file as the usable IDs. As a result, even through a game installed in the recording medium 80 is the same as the game recorded in the game recording medium 70, the additional data file recorded in the recording medium 80 can be copied to the game recording medium 70.

1. An information processing apparatus comprising:
a first recording medium configured to have recorded thereon an application file including an application program and configuration information with which to identify a data file usable by the application program;
a second recording medium configured to have recorded thereon the data file; and
a processor configured to have a function of copying the data file,
wherein the processor includes:
an acquisition unit configured to acquire the configuration information from the first recording medium;
a search unit configured to search the second recording medium for the data file usable by the application program, based on the configuration information acquired by the acquisition unit; and
a copying unit configured to copy to the first recording medium the data file when the data file is detected by the search unit.

2. An information processing apparatus according to claim 1, wherein the first recording medium is a recording medium having a writable area and a read-only area, where the application file has been recorded, and wherein, after the first recording medium is loaded in a receiving section of the information processing apparatus, the processor executes a copying function.

3. An information processing apparatus according to claim 1, wherein the configuration information is information that identifies an application that differs from the application executed by the application program.

4. An information processing apparatus according to claim 1, wherein, when the detected data file has already been recorded in the first recording medium, the copying unit does not copy the data file.

5. A non-transitory, computer-readable medium containing a program executable by a computer, the program comprising:
an acquisition module operative to acquire configuration information from a first recording medium, the first recording medium having recorded thereon an application file including an application program and the configuration information with which to identify a data file that is used by the application program;
a search module operative to search in the second recording medium whereupon data files are recorded for the data file that is used by the application program, based on the acquired configuration information; and
a copying module operative to copy the data file to the first recording medium when the data file is detected.

6. (canceled)
